(19) United States
(12) Patent Application Publication
(10) Pub. No.: US 2009/0240550 A1
(43) Pub. Date: Sep. 24, 2009

(54) Methods and systems for real estate transactions

(75) Inventor: John L. McCarty, Verdi, NV (US)

Correspondence Address: HOLLAND & HART, LLP, P.O BOX 8749, DENVER, CO, 80201, US

(73) Assignee: Suxess, Inc.

(21) Appl. No.: 12/077,820

(22) Filed: Mar. 21, 2008

(51) Int. Cl. G06Q 10/00; G06Q 50/00

(52) U.S. Cl. 705/9

(57) ABSTRACT

A communication hub to facilitate one or more real estate transactions is provided. The communication hub includes a memory to inventory available properties and a pool of appraisers, contracts, inspectors, and the like that may be scheduled via the communication hub to perform necessary or desired services. The communication hub further operates to initiate an escrow and title search for each inventoried or listed property to facilitate cash-out, trade-in, sale, or purchase of the inventoried or listed property.

### FIELD OF THE INVENTION

This disclosure relates generally to methods and systems for real estate services and specifically to systems and methods for assisting the buying and selling of property.

### BACKGROUND OF THE INVENTION

The selling of a home may occur by hiring a licensed realtor or an owner selling the home independent of a realtor (known also as “For Sale By Owner”). Both of these traditional methods of selling a home can be time consuming and costly. The following is a list of occurrences that are involved in practicing methods currently available:
1. The Seller interviews multiple brokers and agents to find the one for which they wish to list the property for sale.
2. The Seller choose a broker or agent to represent their best interests in the sale of their property.
3. The agent makes recommendations of repairs and “dolling-up” property to achieve full market value.
4. The Seller hires contractors and other trade services to complete the portion of the recommendations desired.
5. The seller begins looking for their new home through newspaper classified advertisements, open houses, and other real estate agents.
6. The seller may make offers on another property with a contingency clause. Often these offers are rejected simply because the amount of time is unknown for a close of escrow. Often the contingency is related to the seller's property being sold prior to closing of the new property.
7. The seller waits for an acceptable offer (typically greater than 120 days minimum) to come from another agent or their current agent. If the offer comes from the current listing agent it is called dual representation which is illegal in most states because it is considered impossible to be equally represented in both transactions.
8. The offers may be followed by an earnest money deposit showing good faith in their transaction.
9. Once a decent offer comes in there is a counter offer “game” that takes place clarifying the offer and defining who pays for what.
10. When the offer is accepted by all parties a meeting of the minds has occurred and an escrow is opened with a local title company.
11. The title company searches the title history and guarantees a “Clean Title”. They communicate with the seller's agent, buyer's agent, the lender of the property being purchased and the lender or Broker of the buyer. This is usually a min. of 30 days and many properties fall out of escrow due to the lenders inability to write the loan.
12. The agents schedule the inspection of the property and then the inspectors put a property inspection report together and send it to the buyer's agent.
13. Pest inspection.
14. Structural inspection.
15. The buyer's agent reviews with their client the inspection reports and provides a required repair list to the seller. The buyer's agent sends it to the seller's agent and the seller's agent meets with the seller. If buyer and seller do not agree and can not come to terms this is also when the property can be cancelled.
16. The seller now must have these repairs completed by a licensed contractor. Typically three are required.
17. Roofing contractor.
18. Mold or mildew remediation.
19. Plumber.
20. When the repairs are completed the seller communicates with his/her agent. The agent communicates with buyer's agent and buyer's agent to buyer. The buyer then decides whether or not to require re-inspections.
21. The re-inspections are completed by the original inspectors and are paid to make sure the repairs were actually completed according to applicable building code. Assuming all goes well the inspectors produce another report and communicate the results to the buyer's agent.
22. The lender or broker produces loan documents and delivers them to the title company.
23. During this time period the seller typically packs their belongings and hires a moving company to relocate out of the sold property. Upon close of escrow the seller must fully vacate the property and relocate ensuring the property is transferred in its expected condition to the buyer.
24. The seller goes into escrow on another property as the buyer. Because the two sales are difficult to coordinate it is common for an intermediary residence to be acquired.
25. The sellers may coordinate the move to a short term storage facility or ask for an extended escrow to allow for more time to complete the transaction on their new residence. Many times this is where properties fall out of escrow. If one or more things go wrong in the escrow process, the process may have to start again.
26. The buyers get quotes from various insurance companies and initiate a policy.
27. The buyers and agent go to the title company and sign all corresponding documents. They must also transfer funds to the title company in the form of a cashiers check to act as their down payment.
28. The seller and agent go to the title company and signs documents. This is where the keys to the property are transferred to the rightful owner.
29. The sellers have typically relocated into temporary residence with the remainder of belongings in storage. They wait for the escrow to close on the desired property.

It is noteworthy that the aforementioned list is not all inclusive may require one or more attempts at each occurrence before the transaction is completed.

The options to buy a home are similar to those for selling. For example, a buyer can hire an agent who may search for a home based on ones specifications, take one to see homes and may draw up the appropriate paperwork to make an offer. Alternatively, a buyer can search newspaper, internet, and sign advertisements for a house one desires to purchase. Upon deciding on a home, such buyer may most likely be contacted by an agent who may draw up the appropriate paperwork to make an offer. Regardless of the method chosen, an agent may most likely be paid a fee or commission. In many cases, however, consumers are unable to purchase a new home until their current home is sold. Thus, a buyer may miss out on an opportunity to purchase a home that they desire or if faced with relocating, may have to rent until their current home is sold.

### SUMMARY OF THE INVENTION

The present application relates to a method of conducting real estate transactions, such as the buying, selling, and/or trading of a property via a system of an interactive web-based business that can use the concept of trading in one entity's property for another property.

In one aspect, the embodiments of the present application provide a communication hub that allows access to multiple services often required for a real estate transaction through an application portal interface. The communication hub may, for example, provide access to inspection services, appraisal services, contractor services, lender services, and schedulers to assist with scheduling services.

In another aspect, the embodiments of the present application provide a method to allow substantially simultaneous selling or an existing property and buying of a new property by an owner or multiple owners.

Certain aspects of the present application facilitate the buying, selling and/or trading of a residential or vacation property. One implementation employs a system that provides the property owner/buyer with pertinent information related to the owner/buyer's current property and also provides the owner/buyer with the option to sell the owner/buyer's current residence or vacation property, and/or buy another.

In another aspect, the system can include links to multiple companies to create a one-stop-shop for various aspects of buying, selling, trading, and furnishing ones property. For example, the system may have partnerships with many service providers such as lenders, trade services, furniture and property furnishing companies to provide discounts on one or more resources that may compliment the sale and purchase of a home. In addition, the system may allow an individual to book travel, conduct banking transactions, and/or plan a vacation, all from one site or a group of sites.

In some aspects, the system for performing a real estate transaction may include a communication hub in communication with one or more networks, such as, for example the Internet, a LAN, a WAN, a WLan, a WiFi, private network, or the like.

In another aspect, the communication hub may maintain information about property values, inventory, market trends, and other statistical data relating to property buying and selling.

In still another aspect, the communication hub may allow remote users, such as, for example, owner/buyers and others with management tools for selling and buying property via a website. The website may include software that can combine existing links and web based data, security measures for database, and/or fraud prevention banking.

Possible users of the disclosed system may include general users (such as individuals interested in trading/selling/buying homes or other properties), real estate agents, general contractors (including appraisers, photographers, contractors, or construction workers), lending institutions (such as bankers), other service providers such as executive recruiters.

In certain aspects of the present application, the communication hub can combine existing data from internet sources such as real estate evaluation sites (e.g., Zillow.com via A.P.I.), tax assessor's page, home data sites, recorders office and the like to streamline data compilation into a report or property portfolio. If desired, this information combined with an expected cost analysis calculations that may be provided by the system, may bring the Seller relatively quick, and perhaps instant, offers on the Seller's home.

In certain aspects of the technology, the method of performing a real estate transaction may include a user accessing a system that includes home value information. In other aspects of the technology, the system can include a home evaluation page, which may be a link to a home evaluation site. The home evaluation page may include retail, trade-in value and/or cash-out value evaluations, market trends, equivalents, or the like. The categorization of the types of possible home evaluations may allow a customer to determine which type of evaluation is most desirable for their current needs. For instance, in some embodiments, a user may list the property on the website at retail value, quickly, and perhaps, immediately, sell the property for a cash offer, or trade in the property for another from an inventory of previously traded in or cashed-out properties.

One aspect of the technology includes a “Trade-In” method. The “Trade-In” method may include determining the payoff for any existing loan(s) and allowing the value of the “Trade-In” to serve as a down payment on a new property chosen from inventory of the system or other provider. This can, if desired, allow a seller/buyer to trade-in the current property home and acquire a new property in less time. In an embodiment, the system can be configured to complete a sale and a purchase in less than a predetermined number of days, such as, for example, 30 days, but including as short of a period of a few days.

In a similar aspect of the technology, a “Cash Out” method may be provided. The “Cash Out” method may generate a cash out value based on a predetermined percentage of the property's appraised value. Said figure maybe less than, more than, or equal to trade in value.

In another similar aspect of the technology, a “Suggested Retail Value” valuation method may be provided. The “Suggested Retail Value” method may generate a suggested retail value figure that may assist someone trying to determine what a particular house would be worth on the open market. For example, the method may allow a home to be listed for a fee or even for free, if desired, on the system. The suggested retail value may use available information to generate a “Suggested Retail Value” of equivalents.

The above aspects of the technology may further provide, regardless of whether a user is “Trading-In,” “Cashing Out,” or “Listing” a property, the home as part of the system's inventory. If, for example, the user is opting for the Trade-In method, the Trade-In inventory may provide them and any prospective buyer, with a catalog of homes to choose from to purchase.

In additional aspects, the method of performing a real estate transaction may include a user selecting to trade-in, list, or sell their property. The method may also include the user scheduling additional appointments to facilitate one or more transactions relating to the selected trading, listing, or selling of their property. Such appointments may include an appraisal, inspection and virtual tour photographer. The method and system may allow a user to set the appointments at the user's convenience. For instance, a user may schedule all three services to be performed on the property at generally the same time period, on certain dates or any variation thereof.

The method and system in certain aspects may allow a home inspector to access the website from various locations including a property site. Accessing the website from the property site being inspected may allow the inspector to complete the property inspection and have the information quickly, and perhaps, immediately, listed on such website. In a specific embodiment, the information can be viewed by anyone looking to buy the property. In an additional embodiment, upon completion, the inspection report possibly including pictures and a list of desired repairs maybe sent via the website to the desired services for quick, and perhaps, instant quotes.

In other certain aspects of the technology, the method and system for performing a real estate transaction may permit an appraiser to access the website from various locations including the property site being appraised. In an embodiment, the appraiser may complete the property appraisal and/or list the results quickly and perhaps, immediately on the website. In another embodiment, upon completion, the information maybe viewed by anyone looking to buy property. In an additional embodiment, the appraisal maybe forwarded to various service providers including the bank lending the money to buy the property. In even further embodiments, the property evaluation data may be updated on the website. In an embodiment, the property evaluation data may be updated on the website to reflect applicable costs including, for example, quotes for repairs.

In additional aspects of the technology, the method and system described herein may allow additional service providers access from the home site, including a photographer. In an embodiment, a photographer may access the website on location. For example, a photographer may access the website on the home site to upload information, such as, the virtual tour of the home. In an embodiment, the virtual tour includes interior and/or exterior pictures of the home. In another embodiment, the virtual tour is posted quickly and perhaps, instantly, following creation of the tour.

In other aspects of the technology, the method and system for performing a real estate transaction may allow users to contact multiple entities that are part of the system including lenders, title companies, insurance, movers, home furnishings suppliers, job search engines, head-hunters, banks, travel, storage, companies to buy old furnishings, trade services, realtors, brokers and many more. Thus, not only may an individual who owns a home or desires to own a home possibly utilize the system, but other entities such as businesses may also. In an embodiment, the system can allow customers to access various links to business partners, such as to business partners offering discounts for certain goods and/or services. In particular embodiments, these links may include rental homes/apartments, movers, loans, insurance, escrow companies, furniture stores, job links, handymen, and the like.

In additional aspects of the technology, the method and system for performing a real estate transaction may be of use for employers who are interested in relocating employees. For instance, often employees are not able to sell a residence in the time desired. The time it may take to sell can hold up the ability to successfully relocate and start a new job. In many cases couples are geographically separated; one staying behind until the house sales, the other moving into a rental because the couple can't buy until they sell their existing home. By using the method and system for performing a real estate transaction as disclosed herein, an employee may, for example, “Trade In” an old house, select a new home, hire movers, and buy furniture all within a fraction of time compared to the traditional method which often required contacting multiple vendors.

The method for performing a real estate transaction disclosed herein also may include the sending of a notification, such as an email notification to a service provider such as a title company to facilitate the completion of the real estate transaction. In an embodiment, a notification is sent once a customer/user chooses to accept the terms and conditions and ops for either the trade-in or cash-out method.

In other aspects of the technology, the method can include the transferring of money, once the property has been acquired by the company. For example, the companies lender may transfer money to pay off any existing loans, liens or encumbrances that were identified through escrow via a web-based title insurance company (e.g., partner) while transferring any remaining money directly into a sellers online account. In an embodiment, such money may then be used by the seller for the down-payment and other related services such as moving expenses, travel or furnishings. In an additional embodiment, the money may be transferred into an account of the seller's choice. For instance, if the seller is selling at the cash-out rate the money may be transferred into an account selected by the seller.

In additional aspects of the technology, the method and system for performing a real estate transaction can include the aforementioned seller to choose from the inventory of houses provided by the system. In an embodiment, a buyer may select (such as checking the box for) property of interest and with “one-click” they can accomplish one or more of the following:
Procuring offers from lenders;
Scheduling walk through;
Viewing reports on subject property;
Viewing online virtual tour(s);
Communicate via message board/blogs with other clients;
Procuring insurance quotes;
Arranging appointments such as travel, airfare, rental car etc.;
Purchasing property;
Open escrow;
Set up utility services i.e. phone, cable, power, etc.;
Buying furnishings;
Engaging tradesmen services;
Scheduling movers, storage, etc.;
Liquidating unwanted items; and
Transferring funds, such as transferring funds into escrow.

In another aspect of the technology, the method and system for performing a real estate transaction may be implemented as at least a component of a franchise. In an embodiment, the franchise may be marketed to various geographical regions. In a particular embodiment, the method and system are franchised nationwide. In an additional embodiment, the database and inventory of the system for performing a real estate transaction will increase with each franchise.

In an aspect of the technology, the buyer has completed the sale of an existing property, purchased another, and coordinated the various details by use of the method and system of performing a real estate transaction.

The foregoing summary recites various features and advantages of various embodiments of the invention. It is to be understood that all embodiments need not necessarily include all such features or provide all such advantages or address the issues noted in the background. It is also to be understood that there are additional features and advantages of certain embodiments, and they will become apparent as the specification proceeds.

### BRIEF DESCRIPTION OF THE DRAWING

The preferred and other embodiments are shown in the accompanying drawings in which:

FIG. 1 is a block diagram of a system for performing a real estate transaction.

FIG. 1a is another block diagram of the system for performing a real estate transaction.

FIG. 1b is a screen display of exemplary options associated with the block diagrams of FIGS. 1 and 1a;

FIG. 2 a flow chart illustrating exemplary operational steps associated with performing a real estate transaction.

FIG. 3 is a flow chart illustrating exemplary operational steps associated with performing a real estate transaction.

FIG. 4 is a flow chart illustrating exemplary operational steps associated with performing a real estate transaction.

FIG. 5 is a flow chart illustrating exemplary operational steps associated with performing a pre-appraisal process for listing.

FIG. 6 is a flow chart illustrating exemplary operational steps associated with performing a post-appraisal process for listing.

FIG. 7 is a flow chart illustrating exemplary operational steps associated with performing process completion for listing.

FIG. 8 is a flow chart illustrating exemplary operational steps associated with performing a pre-appraisal process for trading.

FIG. 9 is a flow chart illustrating exemplary operational steps associated with performing a post-appraisal process for trading.

FIG. 10 is a flow chart illustrating exemplary operational steps associated with performing process completion for trading.

FIG. 11 is an illustrative diagram of data structures and flow.

### DETAILED DESCRIPTION

Disclosed herein is an automated method of conducting a real estate transaction that provides a number of novel features, such as, without limitation, the buying, selling, and/or trading of a property via communication hub that provides the ability to trade property for other property. In one embodiment, the system employs links to multiple companies to create generally a one-stop-shop for multiple aspects of buying, selling, trading, and furnishing a home.

Filed herewith and pursuant to 37 C.F.R. § 1.52(e)(5) is a CD-R containing code regarding the technology of the present application. The code contained therein is expressly incorporated herein by reference as if set out in full.

The conventional method of selling a property includes, among other things, listing the property, with/or without a real estate agent who markets the property, for sale. The listing may be in conventional media, such as, a paper, a “for sale” sign, the Internet, or the like. With the current method, a seller typically waits for an acceptable offer, coordinates relocation, finds another residence, and goes through at least one or more escrows with an unknown amount of time and expense before the transaction is complete. The technology of the present invention employs methods and systems that reduce or eliminate the above and other such barriers. For example, in one aspect of the present technology, a seller (sometimes referred to as an owner/buyer) may simply sell the home quickly and perhaps, instantly, and buy another in a fixed period of time if desired. The seller may, of course, opt to pay a tax on the gains instead of purchasing a new property.

One exemplary method of performing a real estate transaction includes a seller accessing the system, such as by establishing a data network, which may include wireless communication with such system. In additional embodiments, the seller may enter the seller's address and quickly (and perhaps, instantly) receive a property value or values. In particular, the value of the property may be calculated in one or more ways, including conventional valuations. Some conventional valuations include basing the value on a “Trade In”, “Cash Out”, and “Retail” values.

The “Trade-In” method, for example, may include determining the payoff for any existing loan(s) because the remaining equity may act as down payments on the new home chosen from the inventory (explained further below). This can be desirable for it may allow a seller/owner/buyer to Trade-In the old home and move into to a new home in a fraction of time associated with the methods currently available. The system may be configured to complete a sale and/or a purchase a predetermined timeframe, such as, for example, in less than 30 days, including as short of a period of a few days.

The “Cash Out” method, for example, may generate a “Cash Out” figure based on a predetermined percentage of the property's appraised value. The “Cash Out” figure, may be less than, more than, or equal to the “Trade-In value above. The “Cash Out” figure may, for example, be based on a percentage difference between appraised value and closing value of equivalent properties.

The “Suggested Retail Value” method, for example, may provide a “Suggested Retail Value” figure that can assist in determining the value of a property on the open market. For example, this figure may be of interest to one interested in the more traditional “For Sale By Owner” method. In some instances, the method can allow sellers to list homes for free on the system, such as on a web site. In other situations, the method may allow sellers to list homes for a fee. A seller may benefit from such listing by adding their homes to the inventory of homes maintained by the system because such listings may then be viewed by multiple viewers looking to buy, sell and/or trade a property.

The disclosed system and method for performing a real estate transaction can eliminate the variables of the current state-of-the-art method that cause delay and sometimes hinder destroy the ability to buy or sell a property. For example, it may facilitate the buying and selling process as well as ease the transition of any type of relocation. In the midst of a declining real estate market, many people are just simply waiting for homes to sell via traditional means in order to purchase the home they want. The waiting period is often costing people money and time. Thus, there can be many attractive features associated with the presently disclosed system and method for performing a real estate transaction. For example, the cost associated with the traditional method of selling and buying a home can be exponential when considering the time involved, costs of agent representation, marketing, preparation of property, and missed opportunities. The presently disclosed system and method can offer a fixed price for trade-in or cash that can be less expensive when all factors are considered.

The methods and system for performing a real estate transaction disclosed herein can eliminate the unknown factors involved with a traditional transaction allowing a consumer to make immediate informed decisions. For example, the consumer can be allowed to take advantage of opportunities such as better job offers, relocating due family emergencies, and acquire the home they choose almost immediately instead of waiting. It is possible that the disclosed methods and system for performing a real estate transaction may be beneficial to the national economy. For example, from the increase turn-over in the real-estate market, the market itself may likely begin to increase. Complimentary businesses may increase with every transaction as may the tax revenue generated from more real-estate transactions. As such, the disclosed methods and systems herein may bring added value to the national economy.

Further, the disclosed methods and system for performing a real estate transaction may allow users to contact multiple entities that are part of the system including lenders, title companies, insurance, movers, home furnishings suppliers, job search engines, head-hunters, banks, travel, storage, companies to buy old furnishings, trade services, realtors, brokers and many more. Thus, not only may an individual who owns a home or desires to own a home benefit from the disclosed system, but other entities such as businesses may also. In an example, the system allows customers to access various links to business partners, such as to business partners offering discounts for certain goods and/or services. Such links may include rental homes/apartments, movers, loans, insurance, escrow companies, furniture stores, job links, handymen, and the like.

In addition, the disclosed methods and system for performing a real estate transaction maybe of use for employers who are needing to relocate employees. Often these employees run into a problem with selling a home. The time it takes to sell can hold up the ability to successfully relocate and start a new job. In many cases couples are geographically separated; one staying behind until the house sells, the other moving into a rental because the couple can't buy until they sell their existing home. By using the disclosed methods and system for performing a real estate transaction as disclosed herein, an employee can, for example, “Trade In” an old house, select a new home, hire movers, and buy furniture all within a fraction of time compared to the traditional method which often required contacting multiple vendors.

### General Considerations

Disclosed below are representative and exemplary embodiments of methods and systems having particular applicability to methods and systems for performing a real estate transaction. However, such application should not be construed as limiting the scope of the present disclosure in any way. Instead, the present disclosure is directed toward all novel and nonobvious features and aspects of the various disclosed methods and systems, and their equivalents, alone and in various combinations and subcombinations with one another.

### TERMS AND ABBREVIATIONS

ASP Application Service Provider

HTML HyperText Markup Language

HTTP HyperText Transfer Protocol

PHP Hypertext Preprocessor

RSS Rich Site Summary or Real Simple Syndication

SMTP Simple Mail Transfer Protocol

SQL Structured Query Language

SSL Secure Socket Layer

TCP/IP Transmission Control Protocol/Internet Protocol

VPN Virtual Private Network

WWW World Wide Web

XML eXtensible Markup Language

Application Service Provider: An organization n(usually a business) that runs one or more applications on their own servers and provides (usually for a fee) access to others. Common examples of services provided this way include web-based software such as Calendar systems, Human Resources tools (timesheets, benefits, etc.), and various applications to help groups collaborate on projects.

Broadband: Connection to the Internet with much greater bandwidth that you can get with a modem. There is no specific definition of the speed of a “broadband” connection but in general any internet connection using DSL or a via Cable-TV may be considered a broadband connection.

Buyer or Buyer's representative: Anyone acting on behalf of a buyer or potential buyer, including for example the buyer's broker and the buyer himself. The buyer represented by the buyer or buyer's representative includes potential buyers and those actually buying.

eXtensible Markup Language (XML): A widely used system for defining data formats. XML can provide a system to define complex documents and data structures such as invoices, molecular data, news feeds, glossaries, inventory descriptions, real estate properties, etc. For example, if a programmer has the XML definition for a collection of data (often called a “schema”), then one can create a program to reliably process any data formatted according to those rules. In an embodiment, XML may be a subset of the SGML specification.

HTML: Coding language that can be used to create Hypertext documents for use on the World Wide Web. HTML may allow can allow one to specify that a block of text, or an image, be linked to another file, such as a file on the Internet. HTML files are often viewed using a “Web Browser”. HTML is loosely based on a system for markup called SGML.

HyperText Transfer Protocol (HTTP): A protocol for moving hypertextfiles across the Internet. In an embodiment, HTTP may involve a client program and an HTTP server program (such as Apache). HTTP is a protocol that may be used in the World Wide Web (WWW).

Internet: A collection of interconnected computer networks, often linked by copper wires, fiber-optic cables, wireless connections, etc. In contrast, the World Wide Web is a collection of interconnected documents and other resources, often linked by hyperlinks and URLs. Thus, the World Wide Web may be accessible via the Internet, as are many other services including e-mail and file sharing.

Internet Protocol Suite: An “Internet protocol suite” may be a collection of standards and protocols organized into layers such that each layer may provide the foundation and the services desired by the layer above. In this conception, the term Internet can refer to computers and networks that communicate using IP (Internet protocol) and TCP (transfer control protocol). Once this networking structure is established, then other protocols can run “on top.” These other protocols are sometimes called services or applications. Hypertext transfer protocol, or HTTP, may be the application layer protocol that links and provides access to the files, documents and other resources of the World Wide Web.

Java: A network-friendly programming language designed by Sun Microsystems. Java is often used to build large, complex systems that involve several different computers interacting across networks, for example transaction processing systems. Java also may be used to create software with graphical user interfaces such as editors, audio players, web browsers, etc. Java also can be used for creating programs that run in small electronic devices, such as mobile telephones. Using small Java programs (called “Applets”), Web pages can include functions such as animations, calculators, and the like.

Hypertext Preprocessor (PHP): A programming language often used for creating software that is part of a web site. The PHP language can be designed to be intermingled with the HTML that is used to create web pages. The PHP code can be read and processed by web server software.

Protocol: On the Internet “protocol” usually refers to a set of rules that define a format for communication between systems. For example, the HTTP protocol may define the format for communication between web browsers and web servers, the IMAP protocol can define the format for communication between IMAP email servers and clients, and the SSL protocol can define a format for encrypted communications over the Internet. Several Internet protocols are defined in RFC documents.

RSS (Rich Site Summary or RDF Site Summary or Real Simple Syndication): A commonly used protocol for syndication and sharing of content used to share the contents of blogs. Mashups are often made using RSS feeds. RSS is an XML-based summary of a web site, usually used for syndication and other kinds of content-sharing. RSS “feeds” can be sources of RSS information about web sites, and RSS “readers” can read RSS feeds and display such content to users.

Secure Socket Layer (SSL): A protocol designed by Netscape Communications that can be used to enable encrypted, authenticated communications across the Internet.

Server: A computing system, or a software system, that provides a service to client software running on other computers. The term can refer to a particular piece of software or equipment, such as a WWW server, or to the machine on which the software is running. A single server machine can have several different server software systems running on it and can provide many different servers to clients on the network. Sometimes server software is designed so that additional capabilities can be added to the main program by adding small programs known as servlets.

Simple Mail Transfer Protocol (SMTP): A protocol that can be used to send electronic mail from server to server on the Internet. SMTP may be defined in RFC 821 and modified by many later RFC's.

Structured Query Language (SQL): A specialized language for sending queries to databases. Most industrial-strength and many smaller database applications can be addressed using SQL. Specific applications can have their own slightly different version of SQL, implementing features unique to that application, but all SQL-capable databases support a common subset of SQL. An example of an SQL statement is: SELECT name, email FROM people_table WHERE contry-‘uk’.

Transmission Control Protocol/Internet Protocol (TCP/IP): A suite of protocols commonly used on the Internet and other networks. TCP/IP software is now supported by major computer operating systems, such as Windows, MAC operating systems, Linux, and others.

Terminal Server: A computing system that is often configured to interact with a plurality of modems, LAN and/or a host machine. Most terminal servers can provide PPP or SLIP services if connected to the Internet.

VPN—(Virtual Private Network): Often refers to a network in which some of the parts are connected using the public Internet, but the data sent across the Internet can be encrypted, so the entire network is “virtually” private.

World Wide Web (WWW or Web): In an example, “WWW” refers to the whole constellation of resources that can be accessed using Gopher, FTP, HTTP, telnet, USENET, WAIS and some other tools. In another example, “WWW” refers to the universe of hypertext servers (HTTP servers), more commonly called “web servers,” which can be the servers that serve web pages to web browsers.

Upload: A process of transferring data (usually a file) from one computing system to another computing system.

### GENERAL EXEMPLARY EMBODIMENTS OF SYSTEMS, METHODS, AND DEVICES

In accordance with the above exemplary descriptions and aspects of the technology of the present application, some exemplary embodiments of the systems, methods, and devices are provided. The exemplary embodiments are exemplary and should not be construed as limiting. Moreover, unless specifically stated otherwise, all systems should be considered exemplary embodiments.

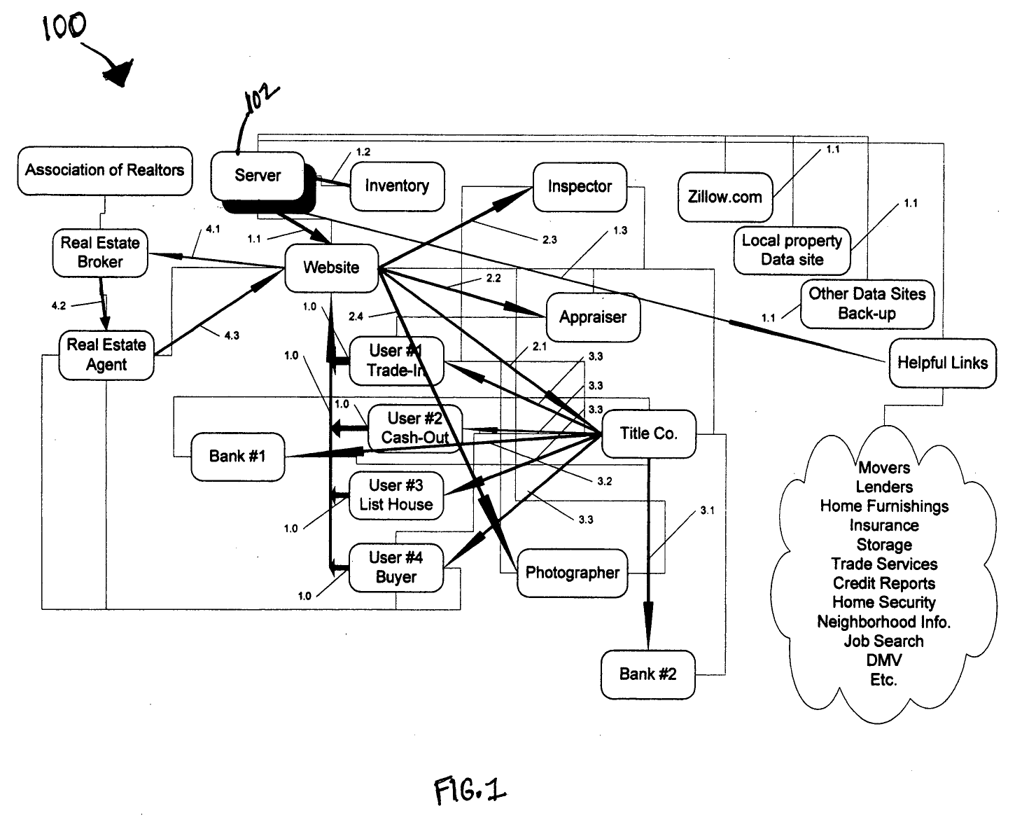

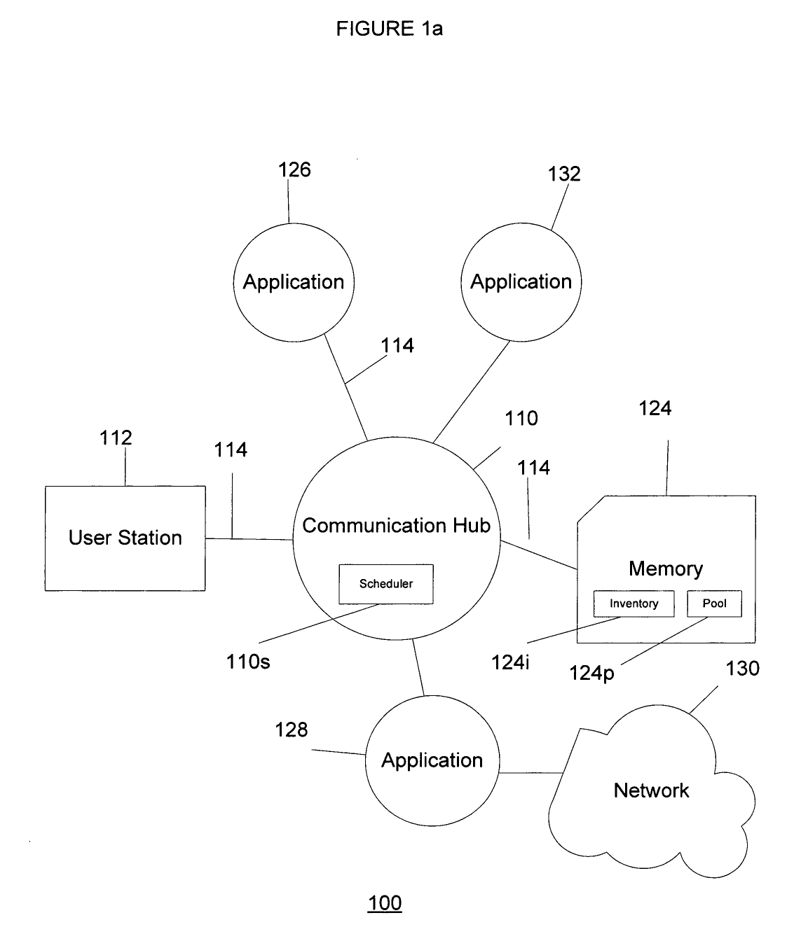

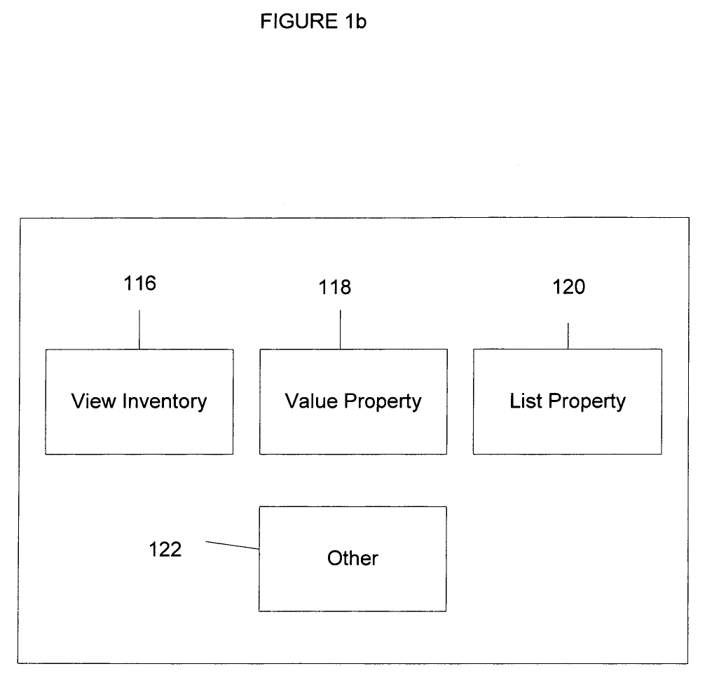

Referring now to FIG. 1, a system for performing a real estate transaction is illustrated in FIG. 1.
1.0 User #1, #2, #4, accesses the Website via internet for information on property. The user has a plurality of choices from which to choose including Home Evaluation, View Inventory of Properties, and Helpful Links.
   1.1 When the user chooses a home evaluation the user can access the server via the website to enter an address and the automation of the property profile may be calculated and represented on the users PC.
   1.2 When a user is looking to buy a property, the user can access the server via the website to view properties listed in the data base/inventory.
   1.3 When a user chooses to go to the helpful Links page, the user can access the server via the website and be connected to one or more companies, such as companies that would be helpful in the sale/purchase of a property.
2.0 When a user chooses to Trade-in property, or Cash-Out Property.
   2.1 an escrow account may be opened at a participating title company;
   2.2 an appraiser can be scheduled;
   2.3 an inspection can be scheduled; and
   2.4 and a Virtual Tour Photographer (such as, but not limited to that listed in Appendix 1) can be scheduled, via the internet.

In an example, all four appointments are made via the internet at the same time. In another example, a user may arrange one or more of the desired appointments via the internet for specific times/dates as desired by the user.

If the user chooses to List the Property for sale all steps are the same except an escrow is only started when another user chooses to buy the subject property.
3.0 The title company activities may include:
   3.1 Performing a title search.
   3.2 Ordering a pay-off loan from existing mortgage company (Bank #2) of the property being sold. When the Title Company receives funds in escrow from lender #1 the funds can be transferred to lender #2 to pay off the old loan. Any remainder of funds due to the seller may be held in an interest baring account for seller until either seller chooses a new property to purchase or chooses to cash out.
   3.3 Sending a request to lender #1 for the correct amount of funds to be deposited into an escrow account. When lender funds loan to the property the money can be sent to the Title Company, such as by a wire transfer or other means.
   3.4 Preparing Title documents for seller to sign and sending documents to Seller and/or Buyer to sign with notary. Once the documents are executed, the Seller and/or Buyer may return the signed documents by any methods including via courier or express mail.
4.0 The Partnering real estate broker activities:
   4.1 Showing properties in interested buyers and to facilitating the key exchanges. When a property is sold to the company an agent working for the partnering Broker may meet with the seller to visually inspect property for the ability to go to the market/website to be sold and/or to accept the keys, from the seller. The agent may place a “lock-box” at the residence containing the keys for potential buyers to access the property. Communication with a partnering real estate broker may originate with an email from the website via the server.
   4.2 An email may automatically be generated from the website/server to the broker. It may either be for a property key exchange request or a request for showings by potential buyers. The email can instruct the broker the time the customer/user/buyer/seller is available.
   4.3 The Broker can send leads to agents and the agents can accept the appointments.
   4.4 The agent can reply online to the website of the
      (a) inspection/condition of the property, (b) successful key exchange, and/or (c) the sale of a property.

Thus, the system 100 includes a computing server 102 in communication with a communications network, such as the Internet, a LAN, or a WAN. The computing server can maintain information about property values, inventory, and market trends. In an embodiment, the computing server can provide remote users and others with management tools for selling and buying property via a website that in certain embodiments includes software that combines existing links and web based data, security measures for database and fraud prevention banking.

Referring now to FIG. 1a, system 100 is shown in another format. System 100 includes a communication hub 110, which may generally be referred to as a network operation center or NOC. Communication hub 110 may comprise one or more servers or racks of servers to process requests and transmit data an queries between applications accessible over a network. As shown in FIG. 1a, a user at user station 112 connects to the communication hub 110 via a communication or data link 114. User station 112 may comprise a processor, such as a desktop computer, a handheld computer, a laptop computer, a cellular telephone, a server station, or the like. Data link 114 may be a local connection, such as a conventional cable connection, ribbon cable connection, an optical connection, a wireless connection such as a Bluetooth connection, or the like. Data link 114 also may be a remote connection such that data link 114 comprises a network connection, such as, for example, a connection over the Internet, a LAN, a WAN, a WLAN, a WWAN, a WiFi, a WPAN, an Ethernet, or the like. It is envisioned that the user station 112 would connect to communication hub 110 over the Internet, however. Generally, user station 112 would be a thin client station in that the system operates from communication hub and does not require programs to be downloaded and provided to user station 112. This may allow the user to access communication hub 110 using any processor capable of connecting to communication hub 110. While shown as a single user station 112 accessing a single communication hub 110, one of ordinary skill in the art will know recognize on reading the disclosure that multiple user stations 112 may connect to the single communication hub 110 and a single user station 112 is shown for convenience. Moreover, communication hub 110 may be a plurality of communication hubs 110 operating individually or in conjunction. Communication hub 110 may access other applications as described further below.

As shown in FIG. 1b, the user accessing communication hub 110 may be provided with a plurality of choices for operations. For example, the user may be presented with options, such as, for example, a view inventory option 116, a value property option 118, a list property option 120, or other options 122 as a matter of overall system design choices.

If, for example, the user selects a view inventory option 116, communication hub 110 may access memory 124 that contains information regarding each property inventoried with system 100. Inventoried property may be stored in an inventory database 124i. Inventorying a property with system 100 is described in more detail herein. Inventoried property may include information, such as, for example, location, pictures of the property, value of the property, recent upgrades, repairs, equivalents, or links to similar properties for the user to review as desired. Memory 124 may be coupled to communication hub 110 using data link 114. Each data link may be different than other data links as a matter of design choice. Memory 124 generally is located on a server associated with communication hub 110, but may be located remotely and/or operated by a separate server.

In any event, communication hub 110 based on the request to view inventory would access memory 124, extract, fetch or retrieve the information requested, based on, for example, zip code, from inventory database 124i and transmit the information for display on user station 112 to the user. The transmission of the information may be a batch transmission or stream. In some cases, the property inventoried may include pictures and text, in other cases, the information may include audio, video, and audio video, or combinations thereof. As users browse the available inventory, the user may store inventoried homes to a “favorite” in memory 124 associated with the user, such as, for example, saving a pointer in a database associated with the particular user so the user can quickly access the favorite as desired. If the inventoried favorite is removed from the system, due to the fact that the property become unavailable (i.e., bought or removed from the system), the favorite may be deleted from the user profile.

Another option provided is the value property option 118. Communication hub 110 would request information from the user regarding the property to be valued. The information may include a lot identification, a street address, or the like. The Communication hub 110 would receive the property identifier and may transmit that information over a data link 114 to an application 126. Application 126 may be a server remote from communication hub 110 or application 126 may be integrated into communication hub. Application 126 would obtain information, for example via state tax records or the like, to generate a value based on a formulation relating to information regarding the property particulars and comparable properties already in the system. Property valuation may be provided by a separate company and contracted or integrated into communication hub 110. One separate valuation options is provided by www.zillow.com or the like. The valuation may include a single valuation, a range of value, or the like.

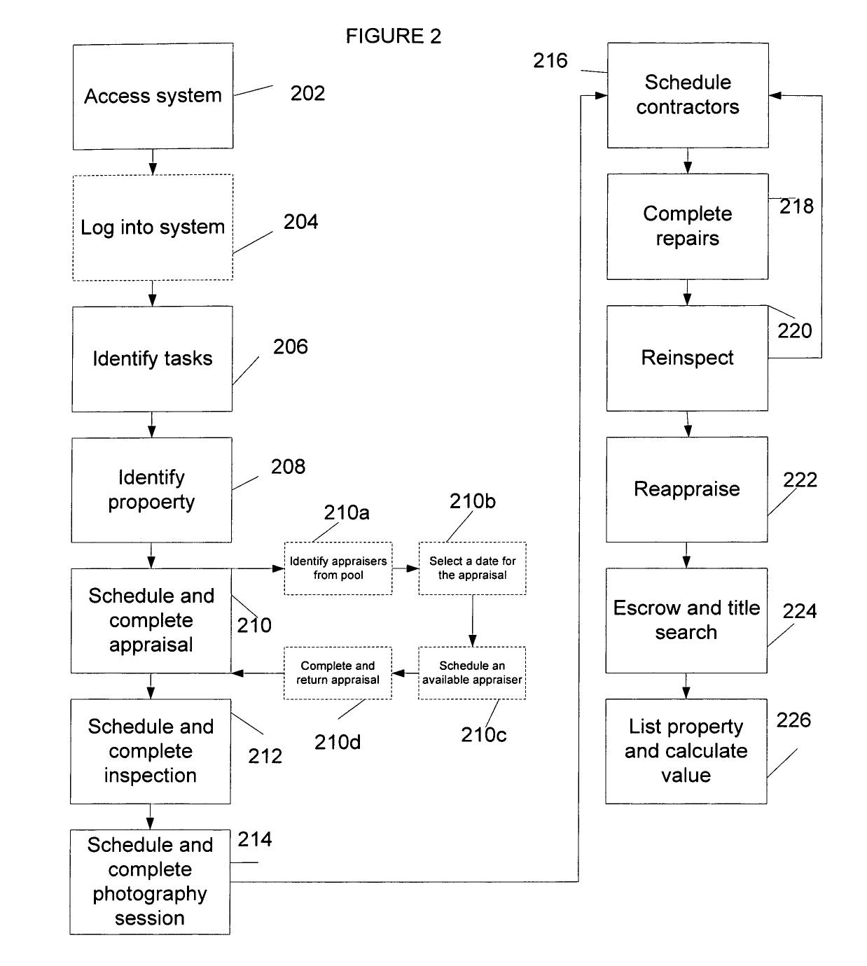

Another option provide is the list property option 118. The list property option may invoke a number of operations as shown in FIG. 1a and FIG. 2. As shown in FIG. 1a, when selected communication hub may access a list property application 128. List property application 128 may be a single integrated module containing all the software and functions to list a property with system 100. Alternatively, and more likely, list property application 128 will access additional information via a network 130 to additional services and applications. Referring to FIG. 2, a flow chart 200 is provided showing exemplary operational steps to list a property with system 100. Listing the property may result in the property being added to inventory database 124i in memory 124. The steps associated with listing property application 128 may be repeated for other similar options. Some other options include, trading property, cashing out property, or the like. Also, the steps associated with exemplary operation 200 may be executed in the order provided, a different order, sequentially, simultaneously, or some combination thereof. Moreover, more, less or different operational steps may be provided to accomplish the same functionality. Certain steps provided below may be separated into multiple additional steps and/or certain combinations of steps outlined individually below may be combined into signal steps without departing from the spirit and scope of the present invention.

First, a user at user station 112 accesses communication hub 110, step 206. Optionally, the user may log into an account using a conventional log in process, step 204. Next, communication hub 110 identifies a list of tasks associated with listing the property, step 206. The list of tasks may include, for example, registering the property of interest, scheduling an appraisal, scheduling an inspection, scheduling contractors, or the like as outlined throughout the present application. Once the various tasks are identified, the system begins action to complete the identified tasks. First, for example, the system prompts the user to identify the property to be listed, step 208. Typically, the property to be listed is identified by a street/mailing address, but other identifiers are possible.

Referring to the above tasks, system 100 may next schedule and complete an appraisal, step 210. Scheduling and completing an appraisal may include accessing a pool of available appraisals stored in memory 124, step 210a. Allowing the property owner to select a date for the appraisal, step 210b. Communication hub would then schedule an available appraiser to appraise the home on the scheduled day, step 210c. Finally, the appraisal would be performed and returned to the property owner, step 210d. If multiple potential appraisers from the pool are available on the selected day, it is possible the property owner may be allowed to select the actual appraiser. Scheduling an available appraiser from the pool of appraisers, which may be stored in a pool database 124p of memory 124, may be facilitated by a scheduler module 110s associated with communication hub 110. While shown integrated, scheduling module 110s may be integrated with or separate from communication hub 110.

System 100 may next schedule and complete a property inspection, step 212. Completing property inspection may include steps 212a-d (not specifically listed) similar to steps 210a-d above, which will not be further explained herein. The inspection report may be saved to memory 124.

System 100 may next schedule and complete a photography session, step 214. Completing a photography session may include steps 214a-d (not specifically listed) similar to steps 210a-d above, which will not be further explained herein. Images and/or videos of the property may be loaded to memory 124 and associated with the identified property to allow individuals viewing inventoried property access to the pictures. A narrative audio may be provided as well as a matter of design choice.

The inspection may result in certain repairs or corrections that need to be made to the property, such as mold removal, pest control, or the like. The appraisal report (or some other similar report) may include suggested repairs or corrections, such as, for example, painting, carpet cleaning, or the like. The reports may further provide property price adjustments should the repair or correction be accomplished. System 100, would schedule contractors to attend to desired repairs, step 216. The contractors would complete the repairs, step 218, and the property may be re-inspected, step 220, to make sure the repairs are satisfactorily completed. Steps 216 to 220 may be repeated until the repairs are satisfactory. Once the repairs are complete and satisfactory, the system may reappraise the property, step 222. At some point during the process, either sequentially or in parallel with other operations, an escrow is opened and a title search conducted for the property, step 224. Eventually, when the various tasks are completed, the property is listed in inventory, step 226. Listing the property generally involves calculating a list price or value. Value may be manually inserted by the user or operator of system 200 or may be automatically determined as is explained further below.

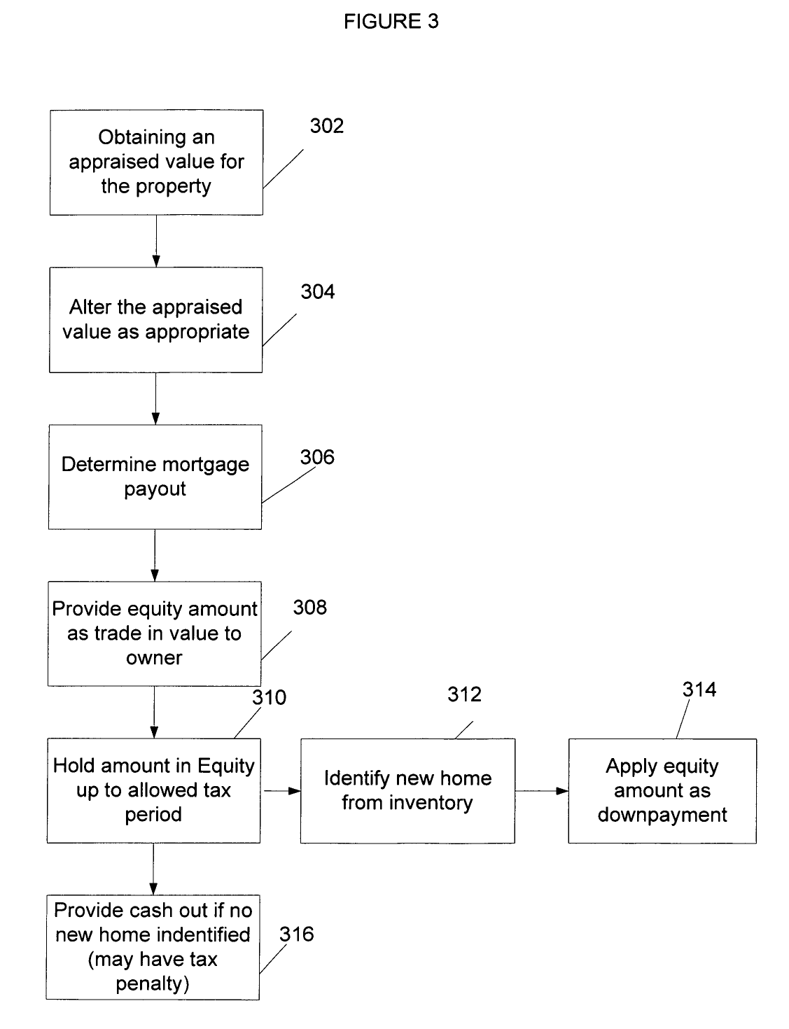

Calculation of value may depend on the type of transaction being applied for. As explained herein, system 100 contemplates multiple opportunities relating to disposing of any listed or inventoried property. In one instance, the value of the property may be a “Cash-Out” value. The cash-out value may be determined as a percentage of the appraised value. For example, if the average comparable or equivalent property sold for 92% of its appraised value, system 100 may offer a cash-out value of the property of 92% of the appraised value. The property owner would receive the cash equivalent, which may be used to pay off the property owner's mortgage or as a down payment, and the property would remain in inventory of system 100. While the cash out value may be equivalent or greater than the average percentage, in most cases the cash-out value will be less than the percentage of appraised value. For example, if a property has an appraised valued of $1,000,000 USD and the average property comparable sells at 90% the appraised value, or $900,000 USD, then the cash-out value may be 85% of the appraised value, or $850,000 USD so the operator of system 100 may make a relative profit of about $50,000 USD in this example. System 100 may provide a suggested list price as well, which is the estimated actual sale price of the property. The suggested retail value may be a percentage of the appraised value or some other calculation as a matter of design choice. Another form of valuation may simply be a recommended list value or suggested retail value. In this example, if properties normally sell at approximately 90% of the appraised value, the suggested list price may be $900,000 USD for a property that appraised at $1,000,000 USD. If properties normally sell at 110% of appraised value, the suggested list price may be $1,100,000 USD, etc. A trade value, or trade in value, as explained further below in connection with FIG. 3, may be the suggested retail price, less a commission, less a mortgage pay-out. For example, if the appraised value of the property is $1,000,000 USD and comparable properties sell for approximately 90% of the appraised value, and the site operator requires a 5% commission from the appraised value, and the mortgage payout is $600,000 USD, the trade in value of the property may be $250,000 USD that the property owner can use as a down payment for a new property contained in inventory.

The exemplary operational steps provided above may be used by multiple different user groups. The user groups may be broadly separated into the following groups.
1. General Users:

Intend to search their location for valuing/trading/selling/buying properties. General users can come from wide and unexpected sources.
2. Real Estate Agents:

Choose from a pool of properties available to show to customers who have scheduled them via the process online. Real estate agents may design their own strategy to bid on homes or select homes based on demographics.
3. Appraisers:

Choose from a pool of property appraisers that may appraise your property. Appraisers may simply provide contact information or additional information to justify their services over others.
4. General Contractor:

Log on and select from list of available jobs to be completed o homes within the system, such as appraiser, contractors, construction workers and other like service providers. General Contractors may reply to a user's enquiry, maintain status logs, update news and information, select jobs for completion and other like activities. General Contractors may also provide estimated time for arrival (ETA) for project completion. General Contractors may make available projects completed and short bio of work that can be performed.

5. Photographers:

Photographers may select or indicate they are available for various potential photography sessions.

Other groups that will use the system, as will become clear below, include:

6. Lending Institutions:

Collect and/or upload data for loans, specials, rates, etc. Lending Institutions may answer users inquiry, respond to loan applications or general questions regarding loans, personal finance, or anything finance related.

7. Insurance Institutions:

Insurance institutions may include moving insurance, title insurance, mortgage insurance or the like.

In an exemplary implementation, the system for performing a real estate transaction may include a website that can reside on a open hardware platform with emphasis on redundancy, quality, reliability, speed, and growth. For example, the website may run on Windows 2003 Enterprise Server running IIS6 and MSSQL Database utilizing standard TCP/IP protocol.

In another exemplary implementation, the applications may be written in Coldfusion and HTML. Cluster technology can be implemented in the beginning of the project to assist with scalability and growth and streamline Implementation. In a specific embodiment, online real estate service providers such as Zillow.com (as provided in Appendix I) can be used to provide the data for the customer.

The system maybe written in Coldfusion, Web 2.0, HTML, XML, JAVA, MSSQL, PHP, Visual C++ code. Zillow API and other API's may be implemented to accommodate the above languages. A feature of ColdFusion is its associated scripting language, ColdFusion Markup Language (CFML), which compares to JSP, C#, or PHP and resembles HTML in syntax. “ColdFusion” can be used synonymously with “CFML”, but it should be noted that there are additional CFML application servers besides ColdFusion, and that ColdFusion supports programming languages other than CFML, such as server-side Actionscript.

Further, HTML 4.01 specification primarily incorporated all the various HTML implementations into a written specification based on SGML. XHTML 1.0, ported this specification, as is, to the new XML defined specification. Next, XHTML 1.1 can take advantage of the extensible nature of XML and modularize the whole specification. XHTML 2.0 maybe used to add new features to the specification in a standards-body-based approach.

ASP.NET attempts to simplify developers' transition from Windows application development to web development by offering the ability to build pages composed of controls similar to a Windows user interface. In an embodiment, Dell Hardware may be employed.

In a specific embodiment, a server module may include the following:

| | |
|---|---|
| Processor: | For example, a processor with up to two Intel ® Xeon ™ |
| | processors with a minimum clock speed of at least 2.8 GHz |
| | Front-side bus speed 800 MHz |
| L2 cache | For example, at least I MB external cache. |
| Memory | |
| Architecture | For example, 144-bit ECC registered PC2-3200 |
| | DDR2 SDRAM DIMMs, with two-way interleaving, rated for 400-MHz |
| | operation. |
| Memory module sockets | For example, six 240-pin. |
| Memory module capacities | 256 MB, 512 MB, 1 GB, or 2 GB |
| Minimum RAM | For example, 8-GB dual-ranked DIMMs |
| | 12-GB single-ranks DIMMs |
| Drives | |
| Hard Drives | |
| SCSI | Up to two 3.5 inch form factor 1-inch, internal, hot-plug, Ultra320 |
| | SCSI |
| Connectors | |
| Externally accessible | |
| Front Custom | Supports multiple (such as two) USB devices and video via |
| | custom cable |
| Video | |
| Video type | ATI Radeon 7000-M video controller |
| Video memory | 16 MB |

In a particular embodiment, the software features can be as follows:

1. System may be Coldfusion

2. Web server may be hosted on Microsoft IIS 6

3. Database may use Microsofts SQL server

4. Client may be able to use multiple types and versions of the latest browser technologies.

5. Zillow API

6. MLS IDX Framing DATA

In a particular embodiment, software process features can be as follows:

1. Designing an agent negotiation logical class function. Web page can use such agent negotiations logical class functions and data from a database to provide the agent-to-agent negotiation web service.

2. Designing algorithms for determining the values of the house or property with variables options.

3. In addition to standard CRC checks, a model of checks and balances maybe created to ensure user is getting correct data.

4. Data outside of the network infrastructure may be encrypted, such as by using 128 bit ssl protocol standards. Port 443 and 80 may remain open on the firewall to assist with web traffic flow.

It is contemplated that any text editor (including Dreamweaver) can be used to make changes to the code and scripting language in which the system is written in. In addition, Queries can be developed within Query Builder or can be also developed within another text editor such as Dreamweaver. Further, a PDF version of documentation may be provided in addition to documentation delivered in the standard Windows help file and format.

Help may also be provided by the following methods. Each function button provides a help function to explain the usage and detail information of a function. By utilizing the help feature, when activated, hovering over each option within the graphical user interface (GUI) may display a short explanation of the function and, in certain circumstances, provide the option for more information, by clicking more information the help results may be displayed to the user, such as within a separate window.

In an embodiment, the interface features can be as follows:

1. User Interfaces

End Users Interface can be a web based html web page. A user's computing system may have a compatible browser (Internet Explorer 4.1+ or Netscape 6.0+) and Internet connection (TCP/IP and HT'TP protocol).

PDA-based interfaces can be available, such as for agents as well as the public. In an embodiment, the interface may be delivered via WPA 2.0 mobile technologies.

User parameters may be submitted by HTTP protocol through browser to web server. A web server can translate these parameters into agent-recognized language. In an embodiment, agents can start the negotiation process through a selected negotiation technology. The results can be stored in the database. A user can receive the result/process status by a request query database through web server. The result can be presented to the user, such as in html format.

2. Hardware Interfaces

Hardware interfaces may include a chassis based server technology and SAN storage VIA fiber channel SCSI arrays. In an embodiment, Raid level 5 can be provided for redundant fail safe data storage. Any of the mentioned hardware may be compatible with Windows 2003.

Server class Pentium processors, such as Xeon, may power the servers and communication equipment. In an embodiment, servers may be run with the maximum allowed RAM configuration for performance and reliability.

Firewall technology may be used to provide for a hardware layer of security. The firewall hardware can filter and log all traffic, in addition to spam filtering, virus blocking, Trojan horse and any other security threats.

Network communications can take place using standard 1 gb backbone switches. Broadband communications can take place over high end routers clustered for fail over redundancy.

Communications may travel over cat 5e or cat 6 ethernet cabling to and from the datamark point where the communications company equipment is terminated.

Client hardware can utilize any device with a internet connection, such as a device that provides for standard HTML and WAP 2.0.

3. Software Interfaces

Coldfusion—dynamic scripting

Servlet and JSP—dynamic web page generator and workplace of negotiation algorithm.

MSSQL Database—data storage (e.g. user login, membership, temporary process data, result).

Browser—software interface present in html format.

Zillow.com API

4. Communications Interfaces

56K dial up network or LAN—use for Internet access

HTTP—web page download protocol to user

HTML—the markup language of interface

XML—extensible markup language

TCP/IP—Internet communication protocol

TCP socket—connection between remote computers

JAVA—Agent communicate using Java objects

SQL—SQL statement

SSL—Secured socket layer

In an embodiment, the software utilized within system 100 may also address the following nonfunctional specifications:

a. Performance Specifications

Upgradability can be the ability to cost-effectively deploy new versions of the product to customers with minimal downtime or disruption. One feature supporting this goal is automatic download of patches and upgrade of the end-user's machine. Also, data file formats that include enough meta-data may be used to allow one to reliably transform existing customer data during an upgrade.

Operability can be the ability to host and operate the software as an Coldfusion (scripting). The system described herein may allow for 99.9% uptime (for example, a small amount of downtime each month—such as, at most 43 minutes downtime each month). Key features supporting the small amount of downtime can be the ability to do hot data backups, and application monitoring.

b. Safety Features

The system may enact with the latest state of the art safety and security measures to ensure its longevity and ability to be updated.

c. Security Features

Access may be controlled with security measures including usernames and passwords. In an example, only administrator users may have access to administrative functions, average users may not.

Details:
Passwords can include a certain number of characters, such as 4-14 characters.
Encrypted communications (SSL) for the website can be used

d. Software Quality Attributes

The business life-cycle of the software may include events that happen over a certain period of time, including several years, from initial purchase decision, through important but infrequent use cases, until a final transaction may be retired. Possible life-cycle requirements can include the following:
Customers can be able to manage the number of homes that they have and make informed decisions to purchase, trade, sell when needed
The product may support daily operations and a year-end audit
The customer data may be stored in a format that can be accessible even after the application has been retired or to provide for regulations deeming data publicly accessible.

### Method for Performing a Real Estate Transaction

In this example, as illustrated in FIG. 2, a method for performing a real estate transaction can include a user accessing the system via user station 112 and browsing the system 100 in order to perform a real estate transaction. The method also can include a user providing information for a property evaluation, as indicated at step 208. For example, the user may provide information including the address of the property in order to obtain a home evaluation. In an example, multiple evaluation reports can be created by accessing information from other property resource services including Zillow.com, state tax records, or the like. After receiving the reports, a user can view the information included within the report such as the various calculations used to arrive at the presented property value. The user may perform a number of different operations at such point, including modifying the report, scheduling an appraisal, inspection, and/or a virtual tour photography. The schedule appraisal, inspection and/or virtual tour photography may be updated by a certified appraiser, inspector or photographer. For example, the inspection reports and photography may be uploaded. The updated information including updated calculations may then be viewed by the user.

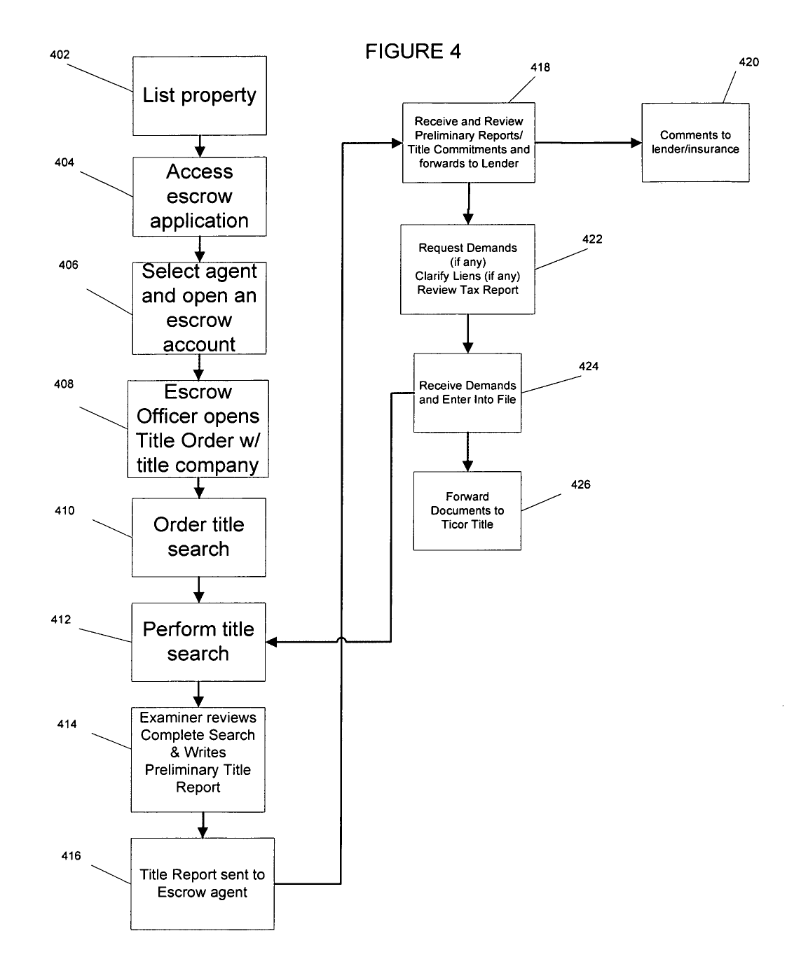

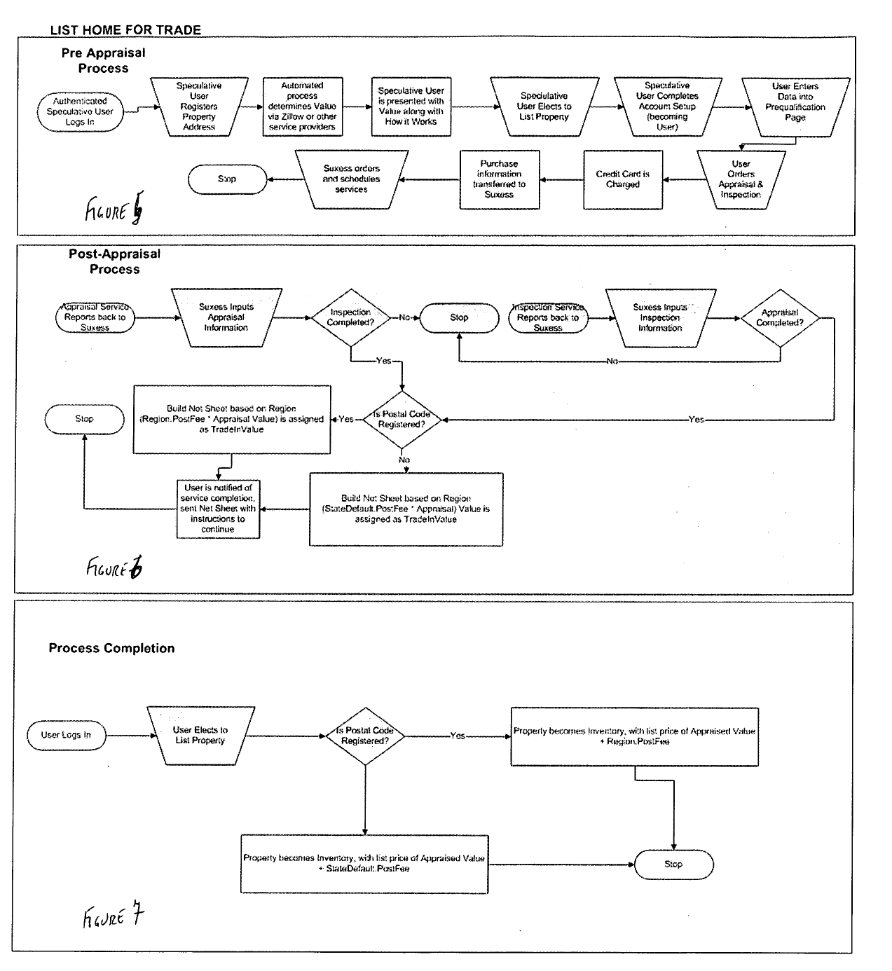

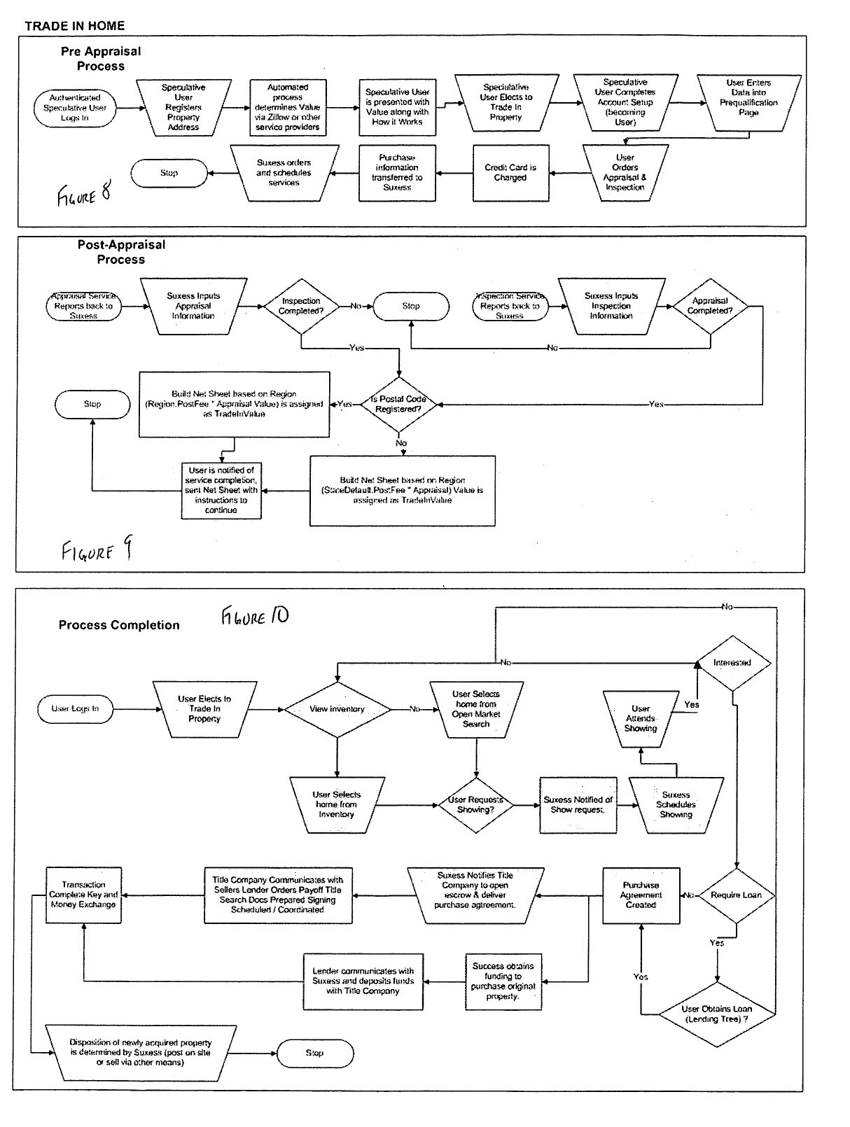

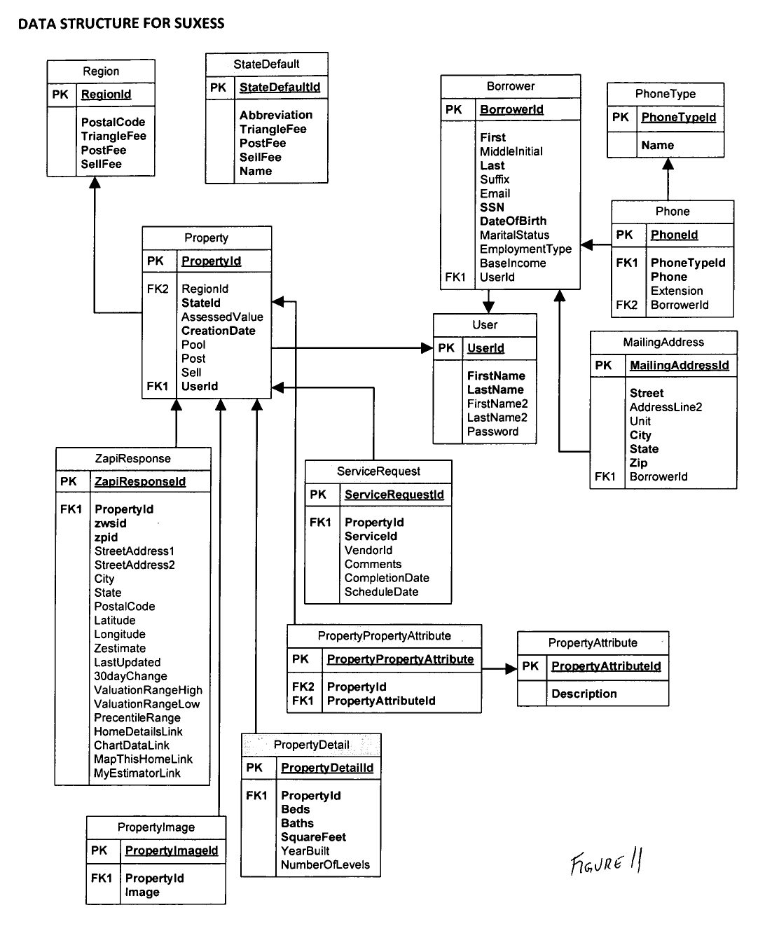

In an example, as illustrated in numerous figures included herewith, the user may decide to trade their home. Once such User agrees to presented Terms and Conditions, an escrow is opened. For example, the escrow account can be opened automatically with a partnering Escrow/Title co. to begin the title search and paperwork. The escrow/title process will be explained further below in connection with FIG. 4. The following steps may occur in order to facilitate the “Trade-in” real estate transaction, as shown in FIG. 3. The trade in option is initiated with obtaining an appraised value for the property, step 302. The appraised value of the property may be deducted for particulars to calculate a trade-in value, step 304. For example, the value of the property may be set at the appraised value, less the percentage of actual sale price as it differs from appraised value, less a commission or the like. Next the mortgage payout is determined, step 306. The difference between the altered value and the mortgage payout is provided as equity to the owner for purchase of a subsequent property, step 308. The amount is transferred and held in an escrow account, step 310. A new property is identified from inventory, step 312, and the equity is applied as a down payment for the new property, step 314. Alternatively, if no new property is identified, the equity may be cashed out, step 316, which may have a tax penalty.

As can be appreciated from the above exemplary operational methods provided herein above and below, several functionalities may be operable via system 100. The functionalities include, for example,

1. Scheduling an Appraisal—selecting possible dates and time that fit the user's schedule.
System may email notices to all partnering Appraisers.
An appraiser who can accommodate the user's schedule can confirm the appointment.

2. Scheduling an Inspection—selecting possible dates and time that fit the user's schedule.
System may email notices to all partnering inspectors.
An inspector who can accommodate the user's schedule confirms the appointment.

3. Scheduling a Photo Shoot for Virtual Tour—selecting possible dates and time that fit the user's schedule
System may email notices to partnering services such as, virtual tour photographers.
A photographer who can accommodate the user's schedule confirms the appointment.

4. Opening an escrow account, performing a title search, etc.

5. Home value is updated, such as updated based on inspection and appraisal reports.

6. Original loan can be paid off
Remaining equity may be transferred to a user's account, such as to a User's Equity account.

The user may also perform the following while arranging for a “Trade-In”:

1. Viewing inventory of homes.
Finding a Home—Entering City and or State
Refining search—For example, entering square footage, bedroom, bathrooms or other like information.

2. Choosing a list of properties to visit.
Viewing virtual tours of selected homes
Viewing reports such as inspection, appraisal and like reports.

3. Scheduling appointments to view the desired homes—selecting dates and time that fit the user's schedule
Booking travel plans if desired
   System can email notices to all partnering Brokerages/Agents.
   An agent that can accommodate the user's schedule can confirm the appointment.
      Agent can send a follow-up email and coordinates details with user.

4. Meeting with agent to view selected homes.

5. Accessing the website
Viewing list of viewed homes
Selecting to Buy a home.

6. Starting loan process
Transferring money from Equity Account for down payment.

7. Selecting a move out date
Coordinating with movers.

8. Procuring insurance quotes, arranging travel, airfare, rental car, purchasing furnishings, liquidating unwanted items, engaging tradesmen services and other like activities.

9. Moving into a new home can be facilitated by having a pool of moving companies that can be scheduled using the scheduling module 132 associated with communication hub to schedule one of the moving companies in the pool, either as available or based on a combination of availability and user preference.

In a further example, the User may decide to “Cash Out” their home. Once such User agrees to presented Terms and Conditions, an escrow is opened. For example, the escrow account is opened automatically with a partnering Escrow/Title co. to begin the title search and paperwork. The following steps may occur in order to facilitate the “Cash Out” real estate transaction:

1. Scheduling an Appraisal—selecting possible dates and time that fit the user's schedule.
System may email notices to all partnering Appraisers.
An appraiser who can accommodate the user's schedule can confirm the appointment.

2. Scheduling an Inspection—selecting possible dates and time that fit the user's schedule.
i. System may email notices to all partnering inspectors.
ii. An inspector who can accommodate the user's schedule confirms the appointment.

3. Scheduling a Photo Shoot for Virtual Tour—selecting possible dates and time that fit the user's schedule
iii. System may email notices to partnering services such as, virtual tour photographers.
iv. A photographer who can accommodate the user's schedule confirms the appointment.

4. Opening an escrow account, performing a title search, etc.

5. Home value is updated, such as updated based on inspection and appraisal reports.

6. Original loan can be paid off
a. Remaining equity maybe transferred to a user's account, such as to a User's Equity account.

7. Selecting a move out date
a. Coordinating with movers

8. Locating a Rental, procuring insurance quotes, arranging travel, airfare, rental Car and the like, purchasing furnishings, liquidating unwanted items, engaging tradesmen services, and other like activities.

9. Moving out
Performing the Final walk through.
Money may be transferred from User's Equity account to the bank account of the user's choice.

10. Utilities. The user may additionally be linked to via a scheduler in to coordinate utility services to turn off services at a property being sold, turn on services at a property being bought, or a combination thereof.

In an even further embodiment, a user may decide to list a property for fee or no-fee, depending upon the circumstances. In an embodiment, the user may follow the following steps to selling and buying a home:

1. Listing of property (for a fee or no-fee).

2. Viewing inventory of homes.
Finding a Home—Entering City and or State
Refining search—For example, entering square footage, bedroom, bathrooms or other like information.

3. Choosing a list of properties to visit.
Viewing virtual tours of selected homes
Viewing reports such as inspection, appraisal and like reports.

4. Scheduling appointments to view the desired homes—selecting dates and time that fit the user's schedule
Booking travel plans if desired
   System can email notices to all partnering Brokerages/Agents.
   An agent that can accommodate the user's schedule can confirm the appointment.
      Agent can send a follow-up email and coordinates details with user.

5. Meeting with agent to view selected homes.

6. Accessing the website
Viewing list of viewed homes
Selecting to Buy a home.

7. Starting loan process
Transferring money from Equity Account for down payment.

In additional embodiments, a user may employ the system 100 to access various links for service providers and goods. In an example, these links can allow the user to access the given services, such as for a discounted fee. Links may include links to find rental homes/apartments, movers, loans, insurance, escrow companies, furniture stores, job links, handymen, credit reports/specialists, home security providers, school reports, neighborhood statistics, travel services, and other like services.

Another aspect of the technology of the present application includes providing a dual or multiple escrow as shown in FIG. 4. As shown in FIG. 4, a property is listed with system 100 either as a list property, a trade-in, or a cash out basis, step 402. System 100 accesses an escrow/title application 132, step 404, and selects an escrow agent to open an escrow account with an available agent as identified in pool 124p, step 406. The escrow agent opens a title order with a title company—which may be separate from system 100 or incorporated within system 100 as a matter of design choice, step 408. Opening the escrow and opening a title search may involve accepting terms and entering a contract, electronic or otherwise. A title search would be ordered, step 410, and performed, step 412. The title search includes, among other things, computerized search of property chains, a manual search of the title indexes, possibly uploading documents, review of engineering and plot maps to confirm property lines, tax and bond record searches. Once complete, the title searcher prepares a title report, step 414, and forwards the report to the escrow agent, step 416. The Escrow agent receives, reviews, and comments on the report, step 418. The escrow agent may provide the report and/or comments to the lender and insurance companies, step 420. The escrow agent may make demands, clarifications, seek releases, etc. depending on the report, step 422. The demands may be received and entered into the various databases, step 424. The title company may re-perform all or a portion of the title search, step 412. Finally, the documents are finalized, step 426.

One reason the above is called a dual or multiple escrow/title procedure is the above process is preformed and the escrow held for every property listed or inventoried with system 100. Thus, when a property owner/buyer is considering buying an inventoried property, the inventoried property already has the escrow opened and the title report completed. Similarly, the property owner's property already has its escrow open and title report in process or completed. This process eliminates the sequential and sometimes barrier to quickly selling and buying property. Thus, while the buyer property and seller property escrows and title searches do not necessarily happen in parallel, the system may be considered a dual or multiple transaction.

### Method for Creating and Using a Database

A database which can be used in any of the examples herein can be created. A graphical user interface (GUI) screen can be developed to define the structure of a database, the GUI screen having a GUI definition. Data entered using the GUI screen can be stored as a data model with a structure, which may be a hierarchical data model, a relational data model, etc. The GUI definition can then be stored as a GUI definition with a similar structure to the data model. When a display model is to be generated, the GUI definition and the data model can be combined to generate a display model which allows entry of data into the database, which may be the database of the system for performing a real estate transaction. If the data model is hierarchical, it can comprise a root and named nodes. In an embodiment, respective named nodes in the hierarchical data entity having unique names. Furthermore, the unique names can comprise relationship paths through the hierarchical data entity.

In another aspect, successive versions of a data model representation of a database can be stored. Each data element within a version has a unique name, while each matching data element across different versions has an identical name. For at least some of the versions of the data model representation, a substantially mirror-image GUI definition is stored as well. Within this GUI definition, substantially all data elements in the data model have similarly-named elements in the GUI definition.

A data model creator can be built. This data model creator can create an acyclic and hierarchical data model. The system can also include a data limner which ensures that respective data locations within a single instantiation of the data model have unique names and that respective data locations within multiple instantiations of the data model have semantically equivalent names. The system further may include a GUI definition creator which creates a GUI definition wherein the GUI definition substantially mirrors the data model. A data model and GUI definition combiner may also be present which combines the data model and the GUI definition to create a combined display model.

### Computing Environment

The following discussion is intended to provide a brief, general description of a computing environment in which the disclosed technology may be implemented. For instance, any of the functionalities described with respect to creating or using an automatically modifiable database GUI and structure (described above) can be implemented in such a computing environment. Although not required, the disclosed technology was described in the general context of computer-executable instructions, such as program modules, being executed by a personal computer (PC). Generally, program modules include routines, programs, objects, components, data structures, etc., that perform particular tasks or implement particular abstract data types.

Moreover, the disclosed technology may be implemented with other computer system configurations, including hand-held devices such as PDAs, multiprocessor systems, microprocessor based or programmable consumer electronics, personal computers (PCs), portable personal computers, network PCs, minicomputers, mainframe computers, and the like. Any number of suitable operating systems maybe used, such as, for example and not limitation, UNIX or one of its many flavors, Linux, one developed by Microsoft for use on PC's, an Apple operating system, an operating system developed specifically for mainframes, such as those developed by IBM, or the like. The disclosed technology may also be practiced in distributed computing environments where tasks are performed by remote processing devices that are linked through a communications network. In a distributed computing environment, program modules may be located in both local and remote memory storage devices.

A generalized example of a suitable computing environment is not intended to suggest any limitation as to scope of use or functionality of the disclosed embodiments, as the present disclosed embodiments may be implemented in diverse general-purpose or special-purpose computing environments. The computing environment includes at least one central processing unit and memory. The central processing unit executes computer-executable instructions and may be a real or a virtual processor. The environment further includes the graphics processing unit GPU for executing such computer graphics operations as vertex mapping, pixel processing, rendering, and texture mapping. In a multi-processing system, multiple processing units execute computer-executable instructions to increase processing power and as such the GPU and CPU can be running simultaneously. The memory may be volatile memory (e.g., registers, cache, RAM), non-volatile memory (e.g., ROM, EEPROM, flash memory, etc.), or some combination of the two. The memory stores software implementing the described methods of creating, using, or facilitating the use of an automated community.

A computing environment may have additional features. For example, the computing environment includes storage, one or more input devices, one or more output devices, and one or more communication connections. An interconnection mechanism (not shown) such as a bus, controller, or network interconnects the components of the computing environment. Typically, operating system software (not shown) provides an operating environment for other software executing in the computing environment, and coordinates activities of the components of the computing environment.

The storage may be removable or non-removable, and includes magnetic disks, magnetic tapes or cassettes, CD-ROMs, CD-RWs, DVDs, or any other medium which can be used to store information and which can be accessed within the computing environment. The storage stores instructions for the software to implement methods of creating, using, or facilitating the use of an automated community.

The input device(s) may be a touch input device such as a keyboard, mouse, pen, or trackball, a voice input device, a scanning device, touchscreen, or another device that provides input to the computing environment. For audio, the input device(s) may be a sound card or similar device that accepts audio input in analog or digital form, or a CD-ROM reader that provides audio samples to the computing environment. The output device(s) may be a display, printer, speaker, CD-writer, or another device that provides output from the computing environment.

The communication connection(s) enable communication over a communication medium to another computing entity. The communication medium conveys information such as computer-executable instructions, compressed graphics information, or other data in a modulated data signal.

These connections may include network connections, which may be wireless connections, may include dial-up connections, and so on. The other computing entity may be a portable communications device such as a wireless handheld device, a cell phone device, and so on.

Computer-readable media are any available tangible media that can be accessed within a computing environment. By way of example, and not limitation, with the computing environment, computer-readable media include memory, storage, communication media, a carrier wave through with the media can be transmitted across a network such as the Internet, and combinations of any of the above.

Moreover, any of the methods, apparatus, and systems described herein can be used in conjunction with creating, using, or facilitating the use of an automated community in a wide variety of contexts.

Although the operations of some of the disclosed methods are described in a particular, sequential order for convenient presentation, it should be understood that this manner of description encompasses rearrangement, unless a particular ordering is required by specific language set forth below. For example, operations described sequentially can be rearranged or performed concurrently. Moreover, for the sake of simplicity, the attached figures may not show the various ways in which the disclosed methods, apparatus, and systems can be used in conjunction with other methods, apparatus, and systems. Additionally, the description sometimes uses terms like “determine” and “identify” to describe the disclosed technology. These terms are high-level abstractions of the actual operations that are performed. The actual operations that correspond to these terms may vary depending on the particular implementation and are readily discernible by one of ordinary skill in the art.

Further, data produced from any of the disclosed methods can be created, updated, or stored on tangible computer-readable media (e.g., tangible computer-readable media, such as one or more CDs, volatile memory components (such as DRAM or SRAM), or nonvolatile memory components (such as hard drives) using a variety of different data structures or formats. Such data can be created or updated at a local computer or over a network (e.g., by a server computer).

1. A system for conducting real estate transactions, the system comprising:
a communication hub, the communication hub operably connected to a user station;
a memory, the memory interconnected with the communication hub, the memory comprising:
an inventory database comprising information concerning inventoried property; and
a pool database comprising information concerning vendors;
a scheduler, the scheduler interconnected with the communication hub to all a user at the operably connected user station to schedule vendors to perform one or more services; and
at least one application operably connected to the communication hub, the at least one application providing at least one service to facilitate purchase or sale of a property,
wherein the communication hub provides integration for the user to facilitate or coordinate the purchase or sale of a property by scheduling at least one vendor to perform at least one service and providing at least one application to facilitate the purchase or sale.

2. The communication hub of claim 1, wherein the vendors are selected from a group of vendors consisting of: appraisers, contractors, photographers, real estate agents, escrow agents, or title companies.

3. The communication hub of claim 1, wherein the at least one application is selected from a group of applications consisting of: a valuation application, a search application, a listing application, a cash-out application, or a trade-in application.

4. A method of conducting a real estate transaction using a server comprising the steps of:
identifying at least one task to be accomplished to support the real estate transaction;
identifying a property associated with the real estate transaction;
scheduling and completing the at least one identified task for the identified property;
opening an escrow for the property;
completing a title search and review for the property;
listing the property to facilitate the real estate transaction; and
calculating at least one value associated with the property, wherein the at least one value relates to the real estate transaction.
